(19) United States
(12) Patent Application Publication
(10) Pub. No.: US 2010/0129725 A1
(43) Pub. Date: May 27, 2010

(54) FUEL CELL BIPOLAR PLATE WITH INTEGRATED SEALING AND FUEL CELL COMPRISING SUCH PLATES

(75) Inventors: Francis Roy, Les Ulis (FR); Guillaume Joncquet, Paris (FR); Gery Adriansen, Antony (FR); Jean-Philippe Poirot-Crouvezier, Saint Georges de Commiers (FR); Patrick Le Gallo, Saint Appolinard (FR)

Correspondence Address: NICOLAS E. SECKEL;Patent Attorney, 1250 Connecticut Avenue, NW Suite 700, WASHINGTON, DC, 20036, US

(73) Assignees: Peugeot Citroen Automobiles SA, Velizy Villacoublay (FR); Commissariat A L'Energie Atomique, Paris (FR)

(21) Appl. No.: 11/993,847

(22) PCT Filed: Jun. 26, 2006
(86) PCT No.: PCT/FR2006/001479

§ 371 Date: Sep. 26, 2008

(30) Foreign Application Priority Data
Jun. 28, 2005 (FR) 0506559

(51) Int. Cl. H01M 8/04

(52) U.S. Cl. 429/437

(57) ABSTRACT

The invention relates to a fuel cell bipolar plate (22) comprising at least one ridge (47, 23a, 33a, 40a, 27a, 35a, 41a, 23a) on at least one of the faces (51) thereof, such as seal at least one fluid circuit in the cell from among the oxidant, fuel and coolant inlet circuits and the oxidant, fuel and coolant outlet circuits, said circuits being formed by stacking openings which are provided in the plate (22) and which form an inlet and an outlet for the oxidant and the fuel (33, 40, 35, 41) respectively and openings which form an inlet and an outlet for the coolant (23, 27) respectively during the assembly of the constituent cells (1) of the fuel cell.

The invention mainly concerns a bipolar plate for a fuel cell.

The invention also concerns a cell of a fuel cell stack comprising such a bipolar plate.

A fuel cell is an electrochemical device that makes it possible to convert chemical energy to electrical energy from a fuel (generally hydrogen) and an oxidant (oxygen or an oxygen-containing gas such as air); the only product of the reaction is water, accompanied by a release of heat and generation of electricity.

Inside the fuel cell, the overall chemical reaction produced by the reactions occurring at the electrodes is the following:

H₂+½O₂→H₂O

A fuel cell can be used to supply electrical energy to any device, such as a computer or a cellular phone, for example, but it can also be used to power a motor vehicle and/or the electrical devices contained in a vehicle.

A fuel cell stack can consist of one or more cells.

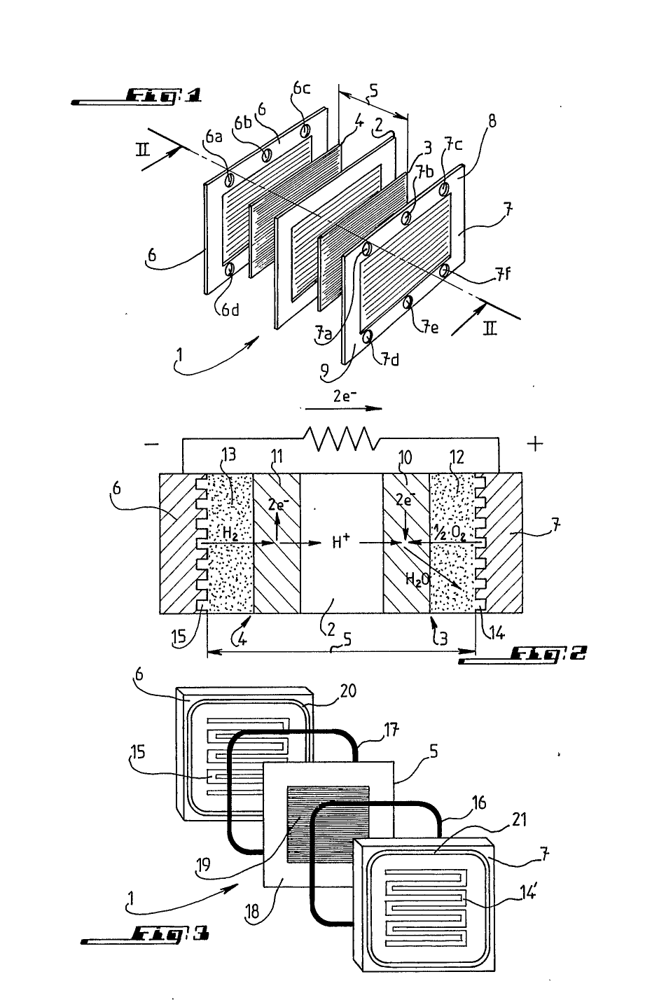

Referring to FIG. 1, which represents a cell of a prior art fuel cell stack, such a cell 1 has a proton-conducting electrolyte 2, sandwiched between a cathode porous electrode 3 and an anode porous electrode 4, that ensures the electron transfer between these two electrodes 3, 4.

To this end, the electrolyte 2 can be a proton exchanging polymer membrane 20 to 200 μm thick, the resulting stack being a PEMFC-type stack (Proton Exchange Membrane Fuel Cell).

The assembly consisting of the electrolyte 2 and the two electrodes 3, 4 forms a membrane electrode assembly (MEA) plate 5 that is itself sandwiched between first 6 and second 7 bipolar plates that collect the current, distribute the oxidant and the fuel to the electrodes and circulate the heat transfer fluid.

The bipolar plates 6, 7 commonly used are made of materials that have good corrosion resistance and electrical conductivity properties, such as carbon materials like graphite, polymer-impregnated graphite, or flexible graphite sheets fabricated by machining or molding them.

The bipolar plates 6, 7 can also be made using metal materials such as titanium-, aluminum- and iron-based alloys, including stainless steels. In this case, the bipolar plate can be fabricated by drawing or stamping thin sheets.

In order to distribute the oxidant, the fuel, and the heat transfer fluid to all of the constituent cells of the stack, the second bipolar plate 7 has six drilled holes 7a, 7b, 7c, 7d, 7e, 7f, three of which 7a, 7b, 7c are evenly spaced on the top edge 8 of this plate 7, with the three other holes 7d, 7e, 7f evenly spaced as well, in a symmetrical manner on the bottom edge 9 of this plate 7.

The first bipolar plate 6 has the same holes located in the same places as those on the bipolar plate 7, with FIG. 1 showing only the three top holes 6a, 6b, 6c and one bottom hole 6d.

The holes 6a, 6b, 6c, 6d in the first bipolar plate 6 and the holes 7a, 7b, 7c, 7d, 7e, 7f in the second bipolar plate 7 must be aligned so that the fluids can circulate through all the constituent cells of the stack when this stack is assembled.

In the area of each of these holes 7a, 7b, 7c, 7d, 7e, 7f, 6a, 6b, 6c, 6d, a conduit that is not shown makes it possible to supply or recover the heat transfer fluid, the fuel or the oxidant circulating on the surface of the plate 6, 7 or inside the plate 6, 7 in fluid circulation circuits or channels provided for this purpose, which will be described below.

Referring to FIG. 2, which is a section along the line II-II in FIG. 1, the cathode 3 and anode 4 electrodes each have a respective active layer 10, 11, which are the cathode and anode reaction sites, respectively, and a respective diffusion layer 12, 13 sandwiched between the active layer 10, 11 and the corresponding bipolar plate 7, 6; this diffusion layer 12, 13 can be a paper substrate or a carbon cloth.

The diffusion layer 12, 13 homogeneously diffuses reagents such as hydrogen and oxygen, which circulate in their respective channels 14, 15, formed by grooves in the respective bipolar plates 7, 6.

In this way, the active layer 11 of the anode electrode 4 is supplied with hydrogen via the diffusion layer 13, and the reaction that occurs in this active layer 11 is the following:

H₂→2e⁻+2H⁺ (1)

In the same way, the active layer 10 of the cathode electrode 3 is supplied with oxygen via the diffusion layer 12, and the reaction that occurs in this active layer 10 is the following:

½O₂+2H⁺+2e⁻→H₂O (2)

These reactions are made possible by the presence of the conductive membrane 2, through which protons are transferred from the active layer 11 of the anode 4 toward the active layer 10 of the cathode 3.

Due to the nature of the fluids used and the electrochemical reactions involved, sealing is an important consideration in the design of a fuel cell stack.

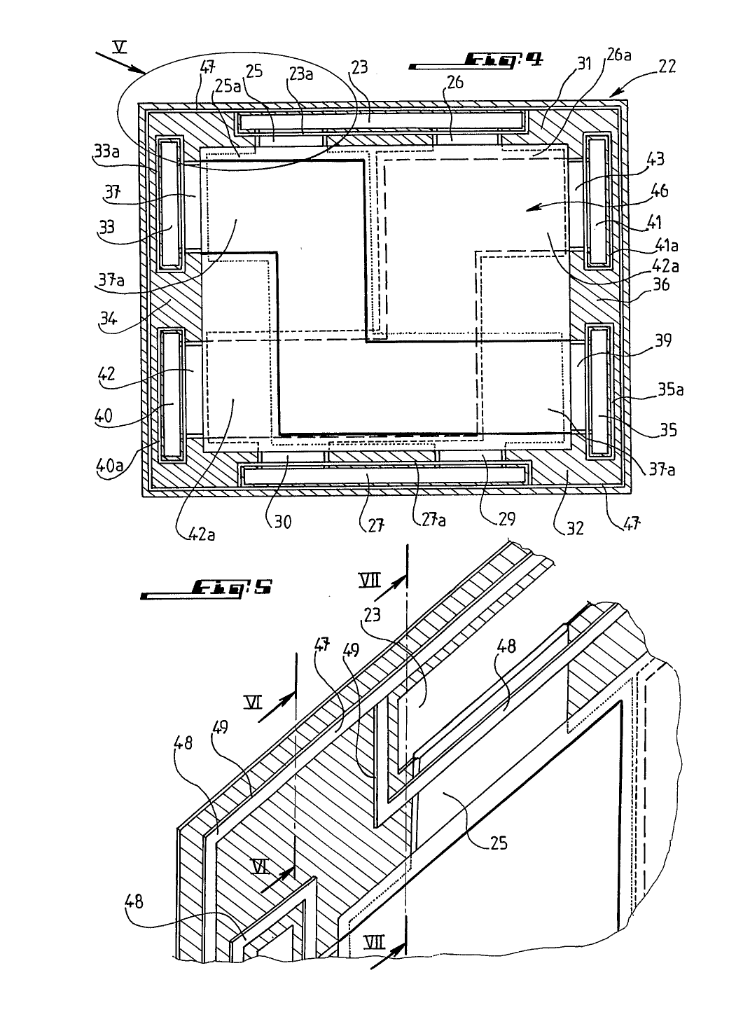

Referring to FIG. 3, which represents a prior art fuel cell, this seal can be formed by the presence of a gasket 16, 17 interposed between the substantially rectangular respective bipolar plates 6, 7 and the membrane electrode assembly plate 5, made up of an active area 19 where the electrochemical reactions take place and a frame 18 surrounding this active area 19.

Referring to the anode part of the cell 1 shown in this figure, when the stack is assembled, the gasket 17 is fitted into a substantially rectangular conjugate peripheral groove 20 in the bipolar plate 6 that surrounds the reagent distribution channels 15.

During this same assembly process, the frame 18 of the assembly plate 5 is made to bear on the whole periphery of the bipolar plate 6 and compresses the corresponding gasket 16, which thereby allows the seal to form between the anode part and the exterior of the stack.

Naturally, in a symmetrical fashion, the bipolar plate 7 in the cathode part of the cell 1 also has a peripheral groove surrounding the oxidant distribution channels of this plate 7 into which the gasket 17 fits; they are neither shown nor referenced due to the angle from which this figure is seen. Thus it is understood that the groove 21 and the distribution channels 14′ of the bipolar plate 7 that are referenced and depicted belong to the anode part of the cell next to the cell 1.

It is also possible to design the groove 20 and its corresponding groove in the bipolar plate of the cathode part so that they are circular in shape, and in this case, the gasket 16 used is an O-ring.

According to prior art, the gasket 16 can also be a flat or serigraphed seal, and in this case, the parts of the cell, particularly the bipolar plates 6, 7 have a shape modified to fit.

It is also possible to have the gasket positioned on the membrane electrode assembly plate 5 rather than being positioned on the bipolar plate before assembly; in this case as well, the parts that make up the cell are appropriately modified.

In the prior art device shown in FIG. 3, the bipolar plates 6, 7 must therefore be fabricated, but the gasket must also meet strict criteria for resistance particularly, in order to seal off the stack.

In this context, the invention particularly concerns a bipolar plate for a fuel cell stack that makes it possible to overcome the difficulties cited above.

To this end, the bipolar plate 22 of the invention is essentially characterized in that it has at least one raised border 47, 23a, 33a, 40a, 27a, 35a, 41a, 23a on at least one of its faces 51, so as to seal off at least one fluid circuit of said stack from among the oxidant, fuel and heat transfer fluid supply circuits and the oxidant, fuel and heat transfer fluid exhaust circuits; said circuits are formed when the constituent cells 1 of the fuel cell stack are assembled by stacking the openings provided in said plate 22 that respectively form oxidant and fuel inlet and outlet means 33, 40, 35, 41 and openings that form heat transfer fluid inlet and outlet means 23, 27.

Advantageously, the bipolar plate of the invention has at least one raised peripheral border 47 enclosing the openings that form reagent inlet and outlet means 33, 40, 35, 41 and the openings that form heat transfer fluid inlet and outlet means 23, 27.

By preference, at least one raised border 23a, 27a, 33a, 40a, 41a, 35a encloses at least one opening from among the openings that form reagent inlet and outlet means 33, 40, 35, 41 and the openings that form heat transfer fluid inlet and outlet means 23, 27, so as to seal off the corresponding fluid circuit when the constituent cells of the stack are assembled.

In this case, a raised border 23a, 27a, 33a, 40a, 41a, 35a can enclose each opening that forms a reagent inlet or outlet means 33, 40, 35, 41 and each opening that forms a heat transfer fluid inlet or outlet means 23, 27, so as to seal off all of the fluid circuits when the constituent cells of the stack are assembled.

In addition, the raised peripheral border 47 can overlap with at least one opening that forms a reagent inlet or outlet means 33, 40, 35, 41 or one opening that forms a heat transfer fluid inlet or outlet means 23, 27 on the outermost part of said raised border 23a, 24a, 27a, 28a.

According to a preferred embodiment, at least one raised border 47, 33a, 35a, 40a, 41a, 23a, 24a, 27a, 28a wholly or partly supports a seal 54.

The raised peripheral border 47 of the plate 22 and the raised borders 33a, 35a, 40a, 41a, 23a, 24a, 27a, 28a of the openings that form inlet and outlet means for reagent 33, 35, 40, 41 and heat transfer fluid 23, 24, 27, 28 are preferably covered by a seal 54.

Moreover, the seal can be a strip and can be serigraphed.

The bipolar plate is advantageously made of a metallic material, but can also be made of expanded graphite or loaded composite.

The raised borders 47, 33a, 35a, 40a, 41a, 23a, 24a, 27a, 28a are preferably formed by drawing or stamping them.

The invention also concerns a cell of a fuel cell stack comprising a membrane electrode assembly plate 50 that has an active area 52 in particular—the anode and cathode reaction sites—and which is sandwiched between two previously described bipolar plates.

The membrane electrode assembly plate 50 has a peripheral frame 53 that preferably bears on at least one raised border 47, 33a, 35a, 40a, 41a, 23a, 24a, 27a, 28a of the bipolar plate 22 when said cell is assembled.

More preferably, the membrane electrode assembly plate 50 has a peripheral frame 53 that bears on all of the raised borders 47, 33a, 35a, 40a, 41a, 23a, 24a, 27a, 28a of the bipolar plate 22 when said cell is assembled.

Advantageously, the membrane electrode assembly plate 50 is mechanically compatible with the bipolar plate 22.

Lastly, the invention also concerns a fuel cell stack comprising at least one above-described cell.

The invention will be more easily understood, and other purposes, advantages, and characteristics thereof will become clearer in the following description, written with reference to the attached drawings, which represent non-limiting examples embodying the device of the invention, and in which:

FIG. 1 is a perspective exploded view of a prior art fuel cell;

FIG. 2 is a sectional view along the line II-II in FIG. 1;

FIG. 3 is a perspective exploded view of a prior art fuel cell;

FIG. 4 is a front view of the bipolar plate of the invention;

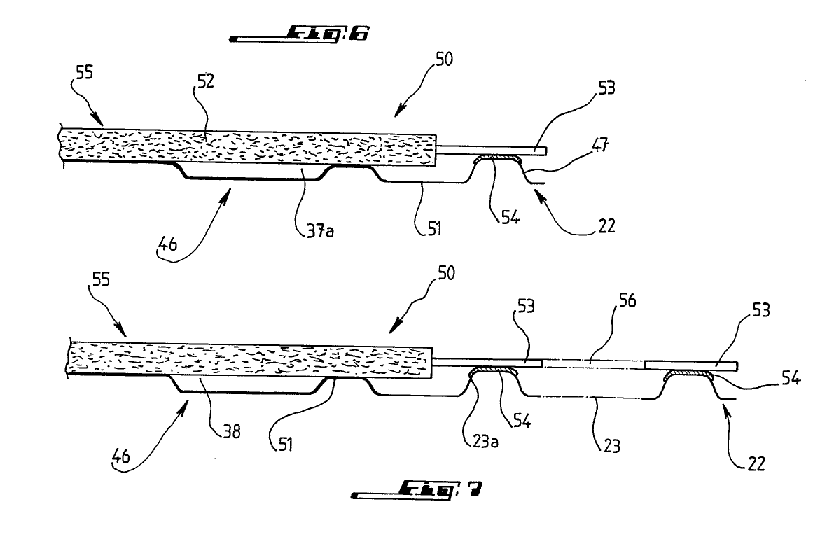

FIG. 5 is an enlarged perspective view of the part circled in FIG. 4, labeled V;

FIG. 6 is a sectional view along the line VI-VI in FIG. 5 of the upper part of the bipolar plate when it is assembled with the membrane electrode assembly plate; and

FIG. 7 is a sectional view along the line VII-VII in FIG. 5 of the upper part of the bipolar plate when it is assembled with the membrane electrode assembly plate.

Referring to FIG. 4, the bipolar plate 22 of the invention is rectangular in shape.

The plate 22 has an inlet window for heat transfer fluid 23 that runs lengthwise at the periphery of the plate 22 along a first longitudinal edge 31, and from which two heat transfer fluid inlet channels 25, 26 formed in the plate 22 extend from the inlet window 23 to the periphery of a rectangular central surface 46, where they enter the plate 22.

These channels 25, 26 introduce the heat transfer fluid into the plate 22 from the inlet window 23; the heat transfer fluid thus introduced circulates within the thickness of the plate in the area of the central surface 46 in distribution channels that are shown schematically and referenced 26a and 25a.

The bipolar plate 22 also has a heat transfer fluid outlet window 27 that runs lengthwise at the periphery of the plate 22 along the second, opposite longitudinal edge 32, from which window two heat transfer fluid outlet channels 29, 30 formed in the plate 22 extend from the rectangular central surface 46 to the window 27, thereby allowing the heat transfer fluid to be collected after circulating through the heat transfer fluid distribution channels 25a, 26a.

When the stack is assembled, the heat transfer fluid inlet 23 and outlet 27 windows in all of the constituent cells of the stack are superimposed, forming a heat transfer fluid circuit consisting of a supply circuit and an exhaust circuit for heat transfer fluid.

The plate 22 also has an oxidant inlet window 33 located at the periphery of the plate 22, running transversely along a first half of a first transverse edge 34 of the plate 22, and an oxidant outlet window 35 located at the periphery of the plate 22, running transversely along one half of the second, opposite transverse edge 36, substantially on the diagonal from the oxidant inlet window 33.

An oxidant inlet channel 37 is formed in the plate 22 and runs from the oxidant inlet window 33 toward the rectangular central surface 46 so that the oxidant diffuses from this inlet channel 37 toward and up to an oxidant distribution channel 37a formed in the bipolar plate 22 on the rectangular central surface 46, which channel is open on top in order to diffuse into the cathode electrode of a membrane electrode assembly plate not shown in this figure, which is intended to bear on the bipolar plate, in the central area 46 more particularly, as will be described below.

An oxidant outlet channel 39 is formed in the plate 22 and extends from the oxidant outlet window 35 toward the central surface 46 so that the oxidant diffuses from the distribution channel 37a through the outlet channel 39 toward the outlet window 35.

When the stack is assembled, the stacking of the windows 33 and 35 of all the constituent cells of the stack forms a fluid circuit that transports the oxidant, composed of an oxidant supply circuit and exhaust circuit.

In symmetrical fashion, the bipolar plate 22 also has a fuel inlet window 40 running transversely along the second half of the first transverse edge 34, and a fuel outlet window 41 running transversely along one half of the second transverse edge 36, placed substantially on the diagonal from the inlet window 40.

The bipolar plate 22 also has a fuel inlet channel 42 and a fuel outlet channel 43 running from the respective fuel inlet 40 and outlet 41 windows toward the central surface 46.

The fuel thus circulates from the inlet window 40 toward the outlet window 41 through a fuel distribution channel 42a formed in the bipolar plate 22, this distribution channel 42a being open on the bottom in order to diffuse into the cathode electrode of a membrane electrode assembly plate not shown in this figure, which is intended to bear on the underside of the bipolar plate.

When the stack is assembled, the stacking of the windows 40 and 41 of all the constituent cells of the stack forms a fluid circuit that transports the fuel, composed of a fuel supply circuit and exhaust circuit.

Referring to FIGS. 4 and 5, the bipolar plate 22 has a peripheral raised border 47 disposed around the entire periphery of the plate 22, enclosing the heat transfer fluid inlet window 23, the oxidant inlet window 33, the fuel inlet window 35, the heat transfer fluid outlet window 27, the oxidant outlet window 35, the fuel outlet window 41, and the rectangular central surface 46 of the bipolar plate 22.

This raised border makes it possible to seal off the interior of the assembled stack from the exterior of this stack.

In addition, the heat transfer fluid inlet window 23, the oxidant inlet window 33, the fuel inlet window 40, the heat transfer fluid outlet window 27, the oxidant outlet window 35, and the fuel outlet window 41 each have a respective raised border 23a, 33a, 35a, 27a, 40a, 41a that seals off each of these windows 23, 33, 40, 27, 35, 41, respectively, when the stack is assembled, as will be described below.

At the heat transfer fluid inlet 23 and outlet 27 windows, the outermost part of the respective raised border 23a, 27a overlaps with the peripheral raised border 47 of the plate 22, whereas at the inlet 33, 40 and outlet 35, 41 windows for oxidant and fuel, respectively, the peripheral border 47 of the bipolar plate 22 encloses each window 33, 40, 41, 35 along with its corresponding raised border 33a, 40a, 41a, 35a.

The peripheral border 47 of the bipolar plate 22, as well as the respective borders 23a, 33a, 40a, 27a, 35a, 41a of the heat transfer fluid inlet window 23, the oxidant inlet window 33, the fuel inlet window 40, the heat transfer fluid outlet window 27, the oxidant outlet window 35, and the fuel outlet window 41 can be formed by drawing or stamping them, and they have a flat front face 48, shown in FIG. 5, parallel to the plane of the bipolar plate 5, being connected thereto by right-angle or oblique edges 22.

Referring to FIG. 6, when the fuel cell stack is assembled, a membrane electrode assembly plate 50 is made to bear on the bipolar plate 22; only the upper face 51 of the bipolar plate 22 that has the oxidant distribution channel 37a is shown in this figure.

The active area 52 of the membrane electrode assembly plate 50 comprises mainly the electrodes and the proton conducting electrolyte, and it bears on the central surface 46 of the bipolar plate 22 in such a way that the reagents circulating in the distribution channel 37a diffuse into the electrode in contact with it.

According to the invention, the membrane electrode assembly plate 50 has a frame 53 that bears on the peripheral border 47 of the bipolar plate 22 without excessive deformation, this border 47 being covered by a serigraphed seal 54.

Assembling the membrane electrode assembly plate 50 and the bipolar plate 22 in this way makes it possible to form the seal between the active area within which the electrochemical reactions occur and the exterior of the cell, and more generally, it also forms the seal between the interior and the exterior of the assembled stack.

It is understood that each bipolar half-plate of the constituent cells in the stack preferably has this peripheral border 47 in order to form the above-mentioned seal.

Referring to FIG. 7, when the frame 53 of the membrane electrode assembly plate 50 is superimposed onto the bipolar plate 22 where the first heat transfer fluid inlet window 23 is located, this frame 53 has a window 56 that aligns with this heat transfer fluid inlet window 23.

In this way, the frame 53 bears on the whole of the raised border of the window 23, which makes it possible to form the seal between the heat transfer fluid inlet window 23 and the exterior of the cell.

It is understood that the frame 53 of the membrane electrode assembly plate 50 is also made to bear at each respective inlet and outlet window for oxidant 33, 35, fuel 40, 41 and heat transfer fluid 23, 27, and that at the respective inlet windows for oxidant 33 and fuel 40 and at the respective outlet windows for oxidant 35 and fuel 41, the frame 53 bears on the peripheral border 33a, 40a, 35a, 41a of each of these windows 33, 40, 35, 41, as well as onto the peripheral border 47, which for these four windows 33, 40, 35, 41 encloses these peripheral borders 33a, 40a, 35a, 41a.

Thus, when the stack is assembled, the whole periphery of the bipolar plate and thus all of the raised borders defined above 47, 23a, 24a, 27a, 28a, 33a, 35a, 40a, 41a come into contact with the frame 53 of the membrane electrode assembly plate 50, and in response to the tightening load, they can be deformed elastically or even plastically so as to conform to the stacking and provide a sufficient linear load on the frame 53.

In this way, the seal between the interior and exterior of the stack is formed by the presence of the peripheral raised border 47 of the bipolar plate, and the specific seal for each of the inlet and outlet windows for reagents 33, 40, 41, 35 or heat transfer fluid 23, 27 is formed by the presence of each of the corresponding raised borders 33a, 40a, 41a, 35a, 23a, 27a.

The frame 53 of the membrane electrode assembly plate 50 is preferably designed to be mechanically compatible with the bipolar plate 22.

1. Bipolar plate for fuel cell stack, which has at least one raised border on at least one of its faces, so as to seal off at least one fluid circuit of said stack from among the oxidant, fuel and heat transfer fluid supply circuits and the oxidant, fuel and heat transfer fluid exhaust circuits, said circuits being formed when the constituent cells of the stack are assembled by stacking the openings provided in said plate that respectively form oxidant and fuel inlet and outlet means and openings that form heat transfer fluid inlet and outlet means, and wherein at least one raised border wholly or partly supports a seal, which is a strip or which is serigraphed.

2. Bipolar plate according to claim 1, which has at least one raised peripheral border enclosing the openings that form reagent inlet and outlet means and the openings that form heat transfer fluid inlet and outlet means.

3. Bipolar plate according to claim 1, wherein at least one raised border encloses at least one opening from among the openings that form reagent inlet and outlet means and the openings that form heat transfer fluid inlet and outlet means, so as to seal off the corresponding fluid circuit when the constituent cells of the stack are assembled.

4. Bipolar plate according to claim 3, wherein a raised border encloses each opening that forms a reagent inlet or outlet means and each opening that forms a heat transfer fluid inlet or outlet means, so as to seal off all of the fluid circuits when the constituent cells of the stack are assembled.

5. Bipolar plate according to claim 2, wherein the raised peripheral border overlaps with at least one opening that forms a reagent inlet or outlet means or at least one opening that forms a heat transfer fluid inlet or outlet means on the outermost part of said raised border.

6. Bipolar plate according to claim 1, wherein the raised peripheral border of the plate and the raised borders of the openings that form inlet and outlet means for reagent and heat transfer fluid are covered by the seal (54).

7. Bipolar plate according to claim 1, which is made of a metal material.

8. Bipolar plate according to claim 1, which is made of expanded graphite or loaded composite.

9. Bipolar plate according to claim 1, wherein the raised borders are formed by drawing or stamping them.

10. Fuel cell comprising at least one membrane electrode assembly plate that has an active area in particular, where the anode and cathode reaction take place, and which is sandwiched between two bipolar plates according to claim 1.

11. Cell according to claim 10, wherein the membrane electrode assembly plate has a peripheral frame that is made to bear on at least one raised border of the bipolar plate when said cell is assembled.

12. Cell according to claim 11, wherein the membrane electrode assembly plate has a peripheral frame that bears on all of the raised borders of the bipolar plate when said cell is assembled.

13. Cell according to claim 11, wherein the frame of the membrane electrode assembly plate is mechanically compatible with the bipolar plate.

14. Fuel cell stack comprising at least one cell according to claim 10.
